(19) United States
(12) Patent Application Publication
(10) Pub. No.: US 2025/0108342 A1
(43) Pub. Date: Apr. 3, 2025

(54) POLYETHYLENE GLYCOL FUNCTIONALIZED AROMATIC POLYIMIDES FOR HIGH PERFORMANCE CO2 CAPTURE APPLICATIONS BEYOND NATURAL GAS PURIFICATION

(71) Applicant: Georgia Tech Research Corporation, Atlanta, GA (US)

(72) Inventors: William J. Koros, Atlanta, GA (US); Yuhe Cao, Atlanta, GA (US)

(21) Appl. No.: 18/901,194

(22) Filed: Sep. 30, 2024

Related U.S. Application Data
(60) Provisional application No. 63/586,103, filed on Sep. 28, 2023.

(51) Int. Cl. B01D 71/64; B01D 53/22; C08G 73/10

(52) U.S. Cl. CPC B01D 71/64; B01D 53/228; C08G 73/1039; C08G 73/1067; B01D 2257/504

(57) ABSTRACT

An exemplary embodiment of the present disclosure provides a membrane comprising a wall configured to interact with a fluid. The wall can comprise a polyimide polymer functionalized with one or more polyethylene glycol (PEG) side groups.

### CROSS-REFERENCE TO RELATED APPLICATIONS

This application claims the benefit of U.S. Provisional Application Ser. No. 63/586,103 filed on 28 Sep. 2023, which is incorporated herein by reference in its entirety as if fully set forth below.

### FIELD OF THE DISCLOSURE

The present disclosure relates generally to systems and methods for separating a component of a fluid, and more particularly to membranes for carbon dioxide (CO₂) separation.

### BACKGROUND

Prior use of polyethylene oxide, polypropylene oxide and related copolymer materials have been used extensively for CO₂ capture from post-combustion flue gases in flat sheet, spiral wound and hollow fiber forms. Examples of prior membranes and membrane materials for CO₂/N₂ separation have been reviewed in detail in, for example: Zhu et al., “Rational design of poly (ethylene oxide) based membranes for sustainable CO₂ capture” Journal of Materials Chemistry A 8, no. 46 (2020): 24233-24252. Materials based on functionalized polyimides with polyethylene glycol side groups, however, have not been considered for this application. Rather, functionalized polyimides have only been considered for crosslinkable materials for stabilization of membranes for aggressive natural gas separations. There is a need for improved membranes having high CO₂ permeance with high CO₂/N₂ selectivity. The present disclosure provides such membranes.

### SUMMARY

An exemplary embodiment of the present disclosure provides a membrane comprising a wall configured to interact with a fluid. The wall can comprise a polyimide polymer functionalized with one or more polyethylene glycol (PEG) side groups.

In any of the embodiments disclosed herein, the polyimide can be an aromatic polyimide.

In any of the embodiments disclosed herein, the polyimide can be a copolyimide.

In any of the embodiments disclosed herein, the copolyimide can comprise two or more monomers selected from the group consisting of: 2,4,6-trimethyl-1,3-phenylene diamine (DAM), oxydianaline (ODA), dimethyl-3,7-diaminodiphenyl-thiophene-5,5′-dioxide (DDBT), 3,5-diaminobenzoic acide (DABA), 2.3,5,6-tetramethyl-1,4-phenylene diamine (durene), meta-phenylenediamine (m-PDA), p-phenylenediamine (PDA), 2,4-diaminotolune (2,4-DAT), tetramethylmethylenedianaline (TMMDA), 4,4′-diamino 2,2′-biphenyl disulfonic acid (BDSA), 1,5-naphthalenediamine (NDA), 4,4″-terphenylenediamine (TDA), 2,2-bis [4-(4-aminophenoxy)phenyl] hexafluoropropane (BDAF), 4,4′-(Hexafluoroisopropylidene) diphthalic anhydride (6FDA), 3,3′,4,4′-biphenyl tetracarboxylic dianhydride (BPDA), pyromellitic dianhydride (PMDA), 1,4,5,8-naphthalene tetracarboxylic dianhydride (NTDA), and benzophenone tetracarboxylic dianhydride (BTDA).

In any of the embodiments disclosed herein, the polyimide can be a fluorinated polyimide.

In any of the embodiments disclosed herein, the polyimide can be 6FDA-DAM:DABA.

In any of the embodiments disclosed herein, the polyimide can be:

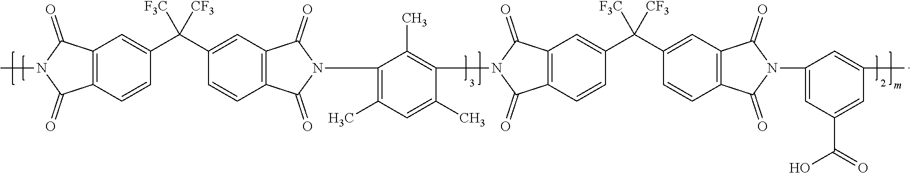

In any of the embodiments disclosed herein, the polyimide can be not cross-linked.

In any of the embodiments disclosed herein, the one or more PEG side groups can be selected from the group consisting of: diethylene glycol (DEG), triethylene glycol (TEG), and teraethylene glycol (TetraEG).

In any of the embodiments disclosed herein, the wall can define one of a hollow-fiber membrane, a flat sheet membrane, a tubular membrane, and a spiral wound membrane.

In any of the embodiments disclosed herein, the membrane can be in the form of a sheath-core membrane comprising a sheath and a core, and the wall of the membrane can define the sheath.

aZIn any of the embodiments disclosed herein, the membrane can have a CO₂/N₂ selectivity greater than 40:1.

In any of the embodiments disclosed herein, the membrane can have a CO₂/N₂ selectivity of 40:1-60:1.

Another embodiment of the present disclosure provides a method of separation, comprising: directing a fluid to a membrane, the fluid comprising a first component, the membrane comprising a polyimide polymer functionalized with one or more polyethylene glycol (PEG) side groups; and separating, with the membrane, at least a portion of first component from the fluid.

In any of the embodiments disclosed herein, the first component can be carbon dioxide (CO₂) and the fluid can be in gaseous form.

These and other aspects of the present disclosure are described in the Detailed Description below and the accompanying drawings. Other aspects and features of embodiments will become apparent to those of ordinary skill in the art upon reviewing the following description of specific, exemplary embodiments in concert with the drawings. While features of the present disclosure may be discussed relative to certain embodiments and figures, all embodiments of the present disclosure can include one or more of the features discussed herein. Further, while one or more embodiments may be discussed as having certain advantageous features, one or more of such features can also be used with the various embodiments discussed herein. In similar fashion, while exemplary embodiments may be discussed below as device, system, or method embodiments, it is to be understood that such exemplary embodiments can be implemented in various devices, systems, and methods of the present disclosure.

### BRIEF DESCRIPTION OF THE DRAWINGS

The following detailed description of specific embodiments of the disclosure will be better understood when read in conjunction with the appended drawings. For the purpose of illustrating the disclosure, specific embodiments are shown in the drawings. It should be understood, however, that the disclosure is not limited to the precise arrangements and instrumentalities of the embodiments shown in the drawings.

FIG. 1 illustrates a synthetic scheme of polyimide polymer, 6FDA-DAM:DABA, functionalized with TEG, according to some embodiments of the present disclosure.

FIG. 2 provides a schematic of a system for manufacturing a sheath-core composite hollow fiber membrane, in accordance with some embodiments of the present disclosure.

FIG. 3 provides SEM images of hollow fiber membranes, in accordance with some embodiments of the present disclosure.

### DETAILED DESCRIPTION

To facilitate an understanding of the principles and features of the various embodiments of the present invention, various illustrative embodiments are explained herein. Although exemplary embodiments of the present invention are explained in detail, it is to be understood that other embodiments are contemplated. Accordingly, it is not intended that the present invention is limited in its scope to the details of construction and arrangement of components set forth in the description or examples. The present invention is capable of other embodiments and of being practiced or carried out in various ways. Also, in describing the exemplary embodiments, specific terminology will be resorted to for the sake of clarity.

It must also be noted that, as used in the specification and the appended claims, the singular forms “a,” “an” and “the” include plural references unless the context clearly dictates otherwise. For example, reference to a component is intended also to include composition of a plurality of components. References to a composition containing “a” constituent is intended to include other constituents in addition to the one named.

Also, in describing the exemplary embodiments, terminology will be resorted to for the sake of clarity. It is intended that each term contemplates its broadest meaning as understood by those skilled in the art and includes all technical equivalents that operate in a similar manner to accomplish a similar purpose.

Ranges may be expressed herein as from “about” or “approximately” or “substantially” one particular value and/or to “about” or “approximately” or “substantially” another particular value. When such a range is expressed, other exemplary embodiments include from the one particular value and/or to the other particular value.

Similarly, as used herein, “substantially free” of something, or “substantially pure”, and like characterizations, can include both being “at least substantially free” of something, or “at least substantially pure”, and being “completely free” of something, or “completely pure”.

By “comprising” or “containing” or “including” is meant that at least the named compound, element, particle, or method step is present in the composition or article or method, but does not exclude the presence of other compounds, materials, particles, method steps, even if the other such compounds, material, particles, method steps have the same function as what is named.

It is also to be understood that the mention of one or more method steps does not preclude the presence of additional method steps or intervening method steps between those steps expressly identified. Similarly, it is also to be understood that the mention of one or more components in a composition does not preclude the presence of additional components than those expressly identified.

The materials described as making up the various elements of the present invention are intended to be illustrative and not restrictive. Many suitable materials that would perform the same or a similar function as the materials described herein are intended to be embraced within the scope of the present invention. Such other materials not described herein can include, but are not limited to, for example, materials that are developed after the time of the development of the present invention.

To facilitate an understanding of the principles and features of the present disclosure, various examples of the disclosed technology are explained herein. The components, steps, and materials described herein as making up various elements of the disclosed technology are intended to be illustrative and not restrictive. Many suitable components, steps, and materials that would perform the same or similar functions as the components, steps, and materials described herein are intended to be embraced within the scope of the disclosure. Such other components, steps, and materials not described herein can include, but are not limited to, similar components or steps that are developed after development of the embodiments disclosed herein.

The present disclosure presents an unrealized opportunity that is an extension of a prior work for natural gas purification involving PEG crosslinked polyimides. Specifically, disclosed herein are membranes for fluid separation, including, but not limited to, the removal of CO₂ from various gases, including flue gases generated from the combustion of fossil fuels, including cement, steel, and power plant flue gases, among others. The membranes can take many different forms, including, but not limited to, flat sheet, spiral wound, tubular, or hollow fiber forms. Further, the membranes disclosed herein can be utilized in many industrial fluid streams, such as flue gases from various industrial plants. The membranes can allow for separation of one or more constituents from the fluid stream, such as CO₂. Thus, the membranes disclosed herein can be utilized to capture CO₂ from flue gas streams with high selectivity.

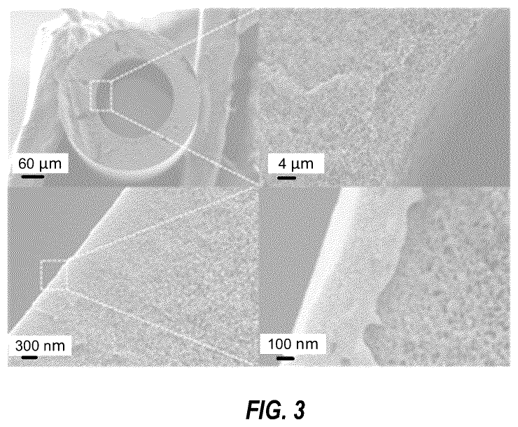

FIG. 3 provides scanning electron microscope (SEM) images of hollow fiber membranes, in accordance with some embodiments of the present disclosure. Though the membranes shown in FIG. 3 take the form of hollow fiber membranes, the disclosure is not so limited. Rather, as those skilled in the art would appreciate, the walls (also referred to herein as sheaths) of the membranes of the present disclosure can take many forms, including, but not limited to, flat sheet membranes, tubular membranes, spiral wound membranes, and the like.

The membranes of the present disclosure provide for improved permeation and selectivity over conventional membranes through the use of novel membrane materials. The disclosed membranes can be based on a carboxylic acid-containing monomer with polyethylene glycol functionalized polyimides that can be used in CO₂ capture. In particular, the wall of membranes of the present disclosure can comprise a polyimide polymer functionalized with one or more polyethylene glycol (PEG) side groups. The membrane walls can include many different polyimides in accordance with various embodiments of the present disclosure. In some embodiments, the polyimide can be a linear polyimide. In some embodiments, the polyimide can be an aromatic polyimide, which can be formed by, for example, a condensation reaction between an aromatic dianhydride and an aromatic diamine. Such aromatic polyimides can have rigid backbone structures with high melting points and high glass transition temperatures (e.g., in excess of 200° C.).

In some embodiments, the polyimide can be a fluorinated polyimide. In some embodiments, the polyimide can be a copolyimide comprising two or more monomers/moieties. In some embodiments, the polyimide can be a copolyimide comprising at least one aromatic dianhydride monomer and at least one diamine monomer. In some embodiments, the dianhydride monomer can be 6FDA. The monomers/moieties can be selected from 2,4,6-trimethyl-1,3-phenylene diamine (DAM), oxydianaline (ODA), dimethyl-3,7-diaminodiphenyl-thiophene-5,5′-dioxide (DDBT), 3,5-diaminobenzoic acide (DABA), 2.3,5,6-tetramethyl-1,4-phenylene diamine (durene), meta-phenylenediamine (m-PDA), p-phenylenediamine (PDA), 2,4-diaminotolune (2,4-DAT), tetramethylmethylenedianaline (TMMDA), 4,4′-diamino 2,2′-biphenyl disulfonic acid (BDSA), 1,5-naphthalenediamine (NDA), 4,4″-terphenylenediamine (TDA), 2,2-bis [4-(4-aminophenoxy)phenyl] hexafluoropropane (BDAF), 4,4′-(Hexafluoroisopropylidene) diphthalic anhydride (6FDA), 3,3′,4,4′-biphenyl tetracarboxylic dianhydride (BPDA), pyromellitic dianhydride (PMDA), 1,4,5,8-naphthalene tetracarboxylic dianhydride (NTDA), benzophenone tetracarboxylic dianhydride (BTDA), and the like.

In some embodiments, the polyimide can be 6FDA-DAM:DABA [4,4′-hexafluoroisopropylidene) diphthalic anhydride (6FDA), 2,4,6-trimethyl-1,3-diaminobenzene (DAM), and 3,5-diaminobenzoic acid (DABA)] functionalized with polyethylene glycol. In some embodiments, the polyimide can have the following structure:

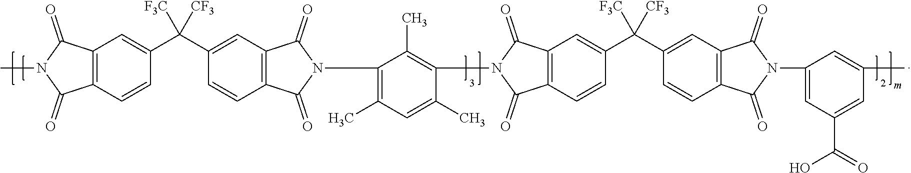

In contrast to certain conventional membranes, polyimides utilized in some embodiments may not be cross-linked.

As discussed above, in some embodiments, the polyimides can be functionalized with one or more polyethylene glycol (PEG) side groups. Many different molecular weight PEG side groups can be utilized. In some embodiments, the PEG side groups can be selected from any one of PEG-n (where n is any integer from 2 to 50). In some embodiments, PEG side groups can be triethylene glycol (TEG). In some embodiments, PEG side groups can be diethylene glycol (DEG). In some embodiments, PEG side groups can be tetraethylene glycol (TetraEG).

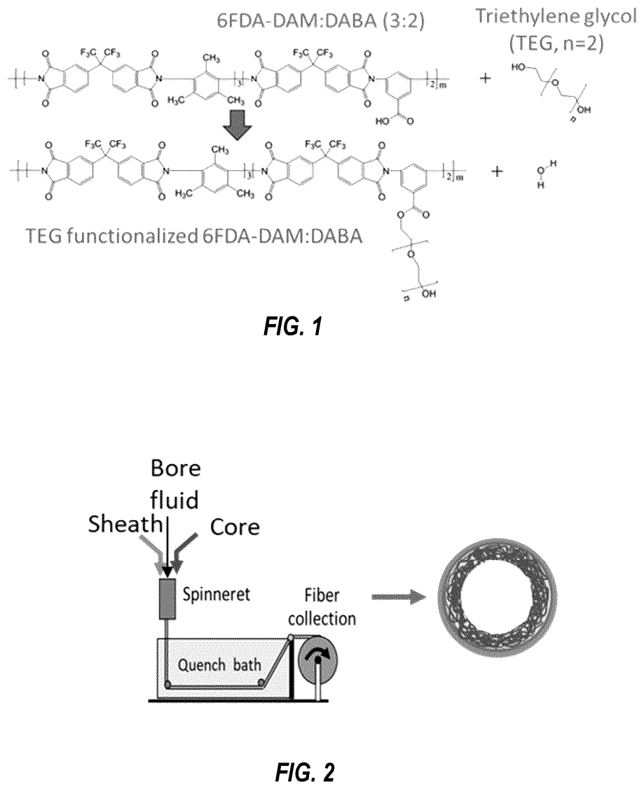

FIG. 1 illustrates a process of synthesizing an exemplary material for use in membranes. In particular, FIG. 1 illustrates the synthesis of polyamide polymer, 6FDA-DAM:DABA (3:2), functionalized with TEG, in accordance with some embodiments of the present disclosure.

In addition to membranes, some embodiments of the present disclosure provide methods of separation utilizing these membranes. An exemplary embodiment provides a method of separation, comprising: directing a fluid to a membrane; and separating, with the membrane, at least a portion of a first component from the fluid. The fluid can be many fluids, including, but not limited to flue gases from industrial plants. The fluid can comprise many components, such as carbon dioxide, nitrogen, and the like. The membrane can allow certain components (e.g., CO₂) to permeate through the membrane, while preventing permeation of other components (e.g., N₂), thus providing for high selectivity. The fluid can contain various components, including CO₂, N₂, water vapor, carbon monoxide, nitrogen oxides, sulfur oxides, and the like. The fluid can predominately contain CO₂ and N₂.

The gas permeation properties of a membrane can be determined by gas permeation experiments. Two intrinsic properties have utility in evaluating separation performance of a membrane material: its “permeability,” a measure of the membrane's intrinsic productivity; and its “selectivity,” a measure of the membrane's separation efficiency. One typically determines “permeability” in Barrer (1 Barrer=10⁻¹⁰ [cm³ (STP) cm]/[cm² s cmHg], calculated as the flux (nᵢ) divided by the partial pressure difference between the membrane upstream and downstream (Δpᵢ), and multiplied by the thickness of the membrane (1):

$${P}_{i} = ( {n}_{i} l ) / ( Δ {p}_{i} )$$

Another term, “permeance,” is defined herein as productivity of asymmetric hollow fiber membranes and is typically measured in Gas Permeation Units (GPU) (1 GPU=10⁻⁶ [cm³ (STP)]/[cm²s cmHg]), determined by dividing permeability by effective membrane separation layer thickness:

$$( {P}_{i} / l ) = ( {n}_{i} ) / ( Δ {p}_{i} )$$

Finally, “selectivity” is defined herein as the ability of one gas's permeability through the membrane or permeance relative to the same property of another gas. It is measured as a unitless ratio.

$${α}_{i / j} = {P}_{i} / {P}_{j} = ( {P}_{i} / l ) / ( {P}_{j} / l )$$

The membranes disclosed herein can provide for high CO₂ permeance and high CO₂/N₂ selectivity. For example, in some embodiments, the membranes can provide a CO₂/N₂ selectivity greater than 20:1, greater than 25:1, greater than 30:1, greater than 35:1, greater than 40:1, greater than 45:1, greater than 50:1, greater than 55:1, greater than 60:1, or greater than 65:1. In some embodiments, membranes can provide a CO₂/N₂ selectivity up to 70:1, up to 65:1, up to 60:1, up to 55:1, up to 50:1, up to 45:1, up to 40:1, up to 35:1, up to 30:1, up to 25:1, or up to 20:1. Additionally in some embodiments, the membranes can provide a CO₂/N₂ selectivity over a range encompassing any of the upper and lower limits disclosed above, such as 20:1 to 70:1, 40:1 to 60:1, 35:1 to 55:1, and the like.

An exemplary membrane comprising TEG functionalized 6FDA-DAM:DABA monolithic fibers was spun and tested with pure gases. Table 1 provides the CO₂ and N₂ permeation results for the TEG functionalized 6FDA-DAM:DABA monolithic fibers at 35° C.

TABLE 1

| ST | N₂ permeance(GPU) | CO₂ permeance(GPU) | α_{CO2/N2} |
|---|---|---|---|
| 1 | 14 | 670 | 47.9 |
| 2 | 12 | 640 | 53.3 |
| 3 | 7.8 | 460 | 59.0 |
| 4 | 17 | 710 | 41.8 |

FIG. 2 provides an illustration of a system for manufacturing membranes of the present disclosure. As shown in FIG. 2, the membranes can be spun as sheath-core composite fiber membranes on an economical support (e.g., Matrimid® or P84®). For example, a less expensive polymer (or other material) can be selected to form a core, and the functionalized polyimide materials disclosed herein can from the sheath. PDMS posttreatment can be applied to eliminate any defects in the selective layer of the composite fiber membrane.

Beyond the specific membranes discussed above, it would be apparent to one skilled in the art that the DABA functionalized polyethylene glycol (PEG) polyimides disclosed herein can be tuned for many CO₂ capture applications, and the present disclosure should be construed as encompassing all of these compositions of matter and applications.

It is to be understood that the embodiments and claims disclosed herein are not limited in their application to the details of construction and arrangement of the components set forth in the description and illustrated in the drawings. Rather, the description and the drawings provide examples of the embodiments envisioned. The embodiments and claims disclosed herein are further capable of other embodiments and of being practiced and carried out in various ways. Also, it is to be understood that the phraseology and terminology employed herein are for the purposes of description and should not be regarded as limiting the claims.

Accordingly, those skilled in the art will appreciate that the conception upon which the application and claims are based may be readily utilized as a basis for the design of other structures, methods, and systems for carrying out the several purposes of the embodiments and claims presented in this application. It is important, therefore, that the claims be regarded as including such equivalent constructions.

Furthermore, the purpose of the Abstract is to enable the United States Patent and Trademark Office and the public generally, and especially including the practitioners in the art who are not familiar with patent and legal terms or phraseology, to determine quickly from a cursory inspection the nature and essence of the technical disclosure of the application. The Abstract is neither intended to define the claims of the application, nor is it intended to be limiting to the scope of the claims in any way.

What is claimed is:

1. A membrane comprising:
a wall configured to interact with a fluid, the wall comprising a polyimide polymer functionalized with one or more polyethylene glycol (PEG) side groups.

2. The membrane of claim 1, wherein the polyimide is an aromatic polyimide.

3. The membrane of claim 1, wherein the polyimide is a copolyimide.

4. The membrane of claim 3, wherein the copolyimide comprises two or more monomers selected from the group consisting of: 2,4,6-trimethyl-1,3-phenylene diamine (DAM), oxydianaline (ODA), dimethyl-3,7-diaminodiphenyl-thiophene-5,5′-dioxide (DDBT), 3,5-diaminobenzoic acide (DABA), 2.3,5,6-tetramethyl-1,4-phenylene diamine (durene), meta-phenylenediamine (m-PDA), p-phenylenediamine (PDA), 2,4-diaminotolune (2,4-DAT), tetramethylmethylenedianaline (TMMDA), 4,4′-diamino 2,2′-biphenyl disulfonic acid (BDSA), 1,5-naphthalenediamine (NDA), 4,4″-terphenylenediamine (TDA), 2,2-bis [4-(4-aminophenoxy)phenyl] hexafluoropropane (BDAF), 4,4′-(Hexafluoroisopropylidene) diphthalic anhydride (6FDA), 3,3′,4,4′-biphenyl tetracarboxylic dianhydride (BPDA), pyromellitic dianhydride (PMDA), 1,4,5,8-naphthalene tetracarboxylic dianhydride (NTDA), and benzophenone tetracarboxylic dianhydride (BTDA).

5. The membrane of claim 1, wherein the polyimide is a fluorinated polyimide.

6. The membrane of claim 1, wherein the polyimide is 6FDA-DAM:DABA.

7. The membrane of claim 5, wherein the polyimide is:

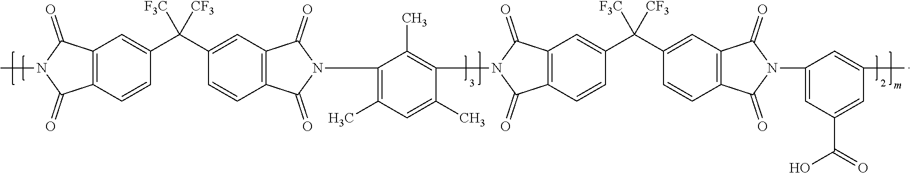

8. The membrane of claim 1, wherein the polyimide is not cross-linked.

9. The membrane of claim 1, wherein the one or more PEG side groups are selected from the group consisting of: diethylene glycol (DEG), triethylene glycol (TEG), and tetraethylene glycol (TetraEG).

10. The membrane of claim 1, wherein the wall defines one of a hollow-fiber membrane, a flat sheet membrane, and a spiral wound membrane.

11. The membrane of claim 1, wherein the membrane has a CO₂/N₂ selectivity greater than 40:1.

12. The membrane of claim 1, wherein the membrane has a CO₂/N₂ selectivity of 40:1-60:1.

13. The membrane of claim 1, wherein the membrane is in the form of a sheath-core membrane comprising a sheath and a core, wherein the wall of the membrane defines the sheath.

14. A method of separation, comprising:
directing a fluid to a membrane, the fluid comprising a first component, the membrane comprising a polyimide polymer functionalized with one or more polyethylene glycol (PEG) side groups; and
separating, with the membrane, at least a portion of first component from the fluid.

15. The method of claim 14, wherein the polyimide is a copolyimide comprising two or more monomers selected from the group consisting of: 2,4,6-trimethyl-1,3-phenylene diamine (DAM), oxydianaline (ODA), dimethyl-3,7-diaminodiphenyl-thiophene-5,5′-dioxide (DDBT), 3,5-diaminobenzoic acide (DABA), 2.3,5,6-tetramethyl-1,4-phenylene diamine (durene), meta-phenylenediamine (m-PDA), p-phenylenediamine (PDA), 2,4-diaminotolune (2,4-DAT), tetramethylmethylenedianaline (TMMDA), 4,4′-diamino 2,2′-biphenyl disulfonic acid (BDSA), 1,5-naphthalenediamine (NDA), 4,4″-terphenylenediamine (TDA), 2,2-bis [4-(4-aminophenoxy)phenyl] hexafluoropropane (BDAF), 4,4′-(Hexafluoroisopropylidene) diphthalic anhydride (6FDA), 3,3′,4,4′-biphenyl tetracarboxylic dianhydride (BPDA), pyromellitic dianhydride (PMDA), 1,4,5,8-naphthalene tetracarboxylic dianhydride (NTDA), and benzophenone tetracarboxylic dianhydride (BTDA).

16. The method of claim 15, wherein the polyimide is 6FDA-DAM:DABA.

17. The method of claim 16, wherein the polyimide is:

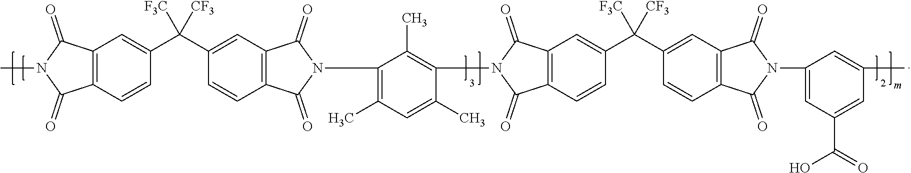

18. The method of claim 14, wherein the one or more PEG side groups are selected from the group consisting of: diethylene glycol (DEG), triethylene glycol (TEG), and tetraethylene glycol (TetraEG).

19. The method of claim 14, wherein the wall defines one of a hollow-fiber membrane, a flat sheet membrane, a tubular membrane, and a spiral wound membrane.

20. The method of claim 14, wherein the first component is carbon dioxide (CO₂), and wherein the fluid is in gaseous form.
